(19) United States
(12) Patent Application Publication
(10) Pub. No.: US 2013/0303245 A1
(43) Pub. Date: Nov. 14, 2013

(54) GAME DEVICE, METHOD OF CONTROLLING A GAME DEVICE, GAME SYSTEM, PROGRAM, AND INFORMATION STORAGE MEDIUM

(71) Applicants: Kengo Shinoda, Misato-shi (JP); Takuya Hashimoto, Ichikawa-shi (JP); Chihiro Tada, Shinagawa-ku (JP); Yasuo Yoshikawa, Nagoya-shi (JP); Yoshinori Mishina, Yokohama-shi (JP)

(72) Inventors: Kengo Shinoda, Misato-shi (JP); Takuya Hashimoto, Ichikawa-shi (JP); Chihiro Tada, Shinagawa-ku (JP); Yasuo Yoshikawa, Nagoya-shi (JP); Yoshinori Mishina, Yokohama-shi (JP)

(73) Assignee: KONAMI DIGITAL ENTERTAINMENT CO., LTD., Minato-ku, Tokyo (JP)

(21) Appl. No.: 13/981,384

(22) PCT Filed: Apr. 25, 2012
(86) PCT No.: PCT/JP2012/061140

§ 371 Date: Jul. 24, 2013

(30) Foreign Application Priority Data
Jun. 30, 2011 (JP) 2011-146885

(51) Int. Cl. A63F 13/00

(52) U.S. Cl. CPC A63F 13/005
USPC 463/2

(57) ABSTRACT

A game system (1) executes a sport video game that uses a moving object (52), and stores evaluation standard data which associates an area (76) in a game space (30) with an evaluation standard for evaluating the result of movement of the moving object (52) from a point inside the area (76). A moving control unit (98) moves the moving object (52) from a moving start point based on the result of detection by a game operation detecting unit (96). A determining unit (100) determines whether or not the result of the movement of the moving object (52) from the moving start point satisfies an evaluation standard that is associated with the area (76) that contains the moving start point. A game operation evaluating unit (102) evaluates a game operation performed by a player based on the result of determination of the determining unit (100).

### TECHNICAL FIELD

The present invention relates to a game device, a method of controlling a game device, a game system, a program, and an information storage medium.

### BACKGROUND ART

Sport video games that use a moving object (for example, a ball, a puck, or a disc) have been known. Patent Literature 1, for example, describes a golf video game in which a ball is moved based on a player's operation.

### CITATION LIST

### Patent Literature

[Patent Literature 1] JP 2009-106563 A

### SUMMARY OF INVENTION

### Technical Problem

With the technology of Patent Literature 1, however, a game operation by a player is evaluated based on the rules of the sport (e.g., golf rules) and the specifics of play are not reflected in the evaluation, which may cause dissatisfaction to the player. For instance, the golf game of Patent Literature 1 rates the relative merits of a player based on the golf score (the number of shots), and does not credit a challenging shot of high difficulty level that the player has gamely made if there is a difference in number of shots between the player and another player who has not tried a shot of high difficulty level.

The present invention has been made in view of the problem described above, and an object of the present invention is therefore to provide a game device, a method of controlling a game device, a game system, a program, and an information storage medium which are capable of evaluation processing that satisfies players in a sport video game that uses a moving object.

### Solution to Problem

In order to solve the above-mentioned problem, according to the present invention, there is provided a game device for executing a sport video game that uses a moving object, including: means for obtaining evaluation standard data, which associates an area in a game space with an evaluation standard for evaluating a result of movement of the moving object from a point inside the area, from means for storing the evaluation standard data; moving control means for moving the moving object from a moving start point based on a game operation performed by a player; determining means for determining whether or not a result of movement of the moving object from the moving start point satisfies the evaluation standard that is associated with the area that contains the moving start point; and game operation evaluating means for evaluating the game operation performed by the player based on a result of the determination of the determining means.

According to the present invention, there is also provided a method of controlling a game device for executing a sport video game that uses a moving object, the method including: a step of obtaining evaluation standard data, which associates an area in a game space with an evaluation standard for evaluating a result of movement of the moving object from a point inside the area, from means for storing the evaluation standard data; a moving control step of moving the moving object from a moving start point based on a game operation performed by a player; a determining step of determining whether or not a result of movement of the moving object from the moving start point satisfies the evaluation standard that is associated with the area that contains the moving start point; and a game operation evaluating step of evaluating the game operation performed by the player based on a result of the determination of the determining step.

According to the present invention, there is further provided a game system for executing a sport video game that uses a moving object, including: means for obtaining evaluation standard data, which associates an area in a game space with an evaluation standard for evaluating a result of movement of the moving object from a point inside the area, from means for storing the evaluation standard data; game operation detecting means for detecting a game operation performed by a player; moving control means for moving the moving object from a moving start point based on a result of detection by the game operation detecting means; determining means for determining whether or not a result of movement of the moving object from the moving start point satisfies the evaluation standard that is associated with the area that contains the moving start point; and game operation evaluating means for evaluating the game operation performed by the player based on a result of the determination of the determining means.

According to the present invention, there is further provided a program for causing a computer to function as a game device for executing a sport video game that uses a moving object, the game device including: means for obtaining evaluation standard data, which associates an area in a game space with an evaluation standard for evaluating a result of movement of the moving object from a point inside the area, from means for storing the evaluation standard data; moving control means for moving the moving object from a moving start point based on a game operation performed by a player; determining means for determining whether or not a result of movement of the moving object from the moving start point satisfies the evaluation standard that is associated with the area that contains the moving start point; and game operation evaluating means for evaluating the game operation performed by the player based on a result of the determination of the determining means.

According to the present invention, there is further provided a non-transitory computer-readable information storage medium having recorded thereon the above-mentioned program.

According to the present invention, it is possible to evaluate processing that satisfies players in a sport video game that uses a moving object.

Further, according to an aspect of the present invention, the evaluation standard indicated by the evaluation standard data indicates a standard for at least one of a moving path, arrival point, moving direction, moving speed, and moving distance of the moving object from the point inside the area, and the determining means determines whether or not at least one of the moving path, arrival point, moving direction, moving speed, and moving distance of the moving object from the moving start point satisfies the evaluation standard that is associated with the area that contains the moving start point.

Further, according to an aspect of the present invention, the game device further includes means for obtaining evaluation information about a method of evaluating the game operation performed by the player from means for storing the evaluation information in association with the evaluation standard, and, in a case where the result of the movement of the moving object from the moving start point satisfies the evaluation standard that is associated with the area that contains the moving start point, the game operation evaluating means evaluates the game operation performed by the player based on the evaluation information that is associated with the evaluation standard.

Further, according to an aspect of the present invention, the game device further includes guidance means for presenting guidance to the player on the evaluation standard that is associated with the area that contains the moving start point, and the determining means determines whether or not the result of the movement of the moving object from the moving start point satisfies the evaluation standard that is presented by the guidance means.

Further, according to an aspect of the present invention, the game device further includes specification receiving means for receiving specification about the evaluation standard that is associated with the area that contains the moving start point from any one of the player, an opponent of the player, and a user watching the game, and the determining means determines whether or not the result of the movement of the moving object from the moving start point satisfies the specified evaluation standard which is received by the specification receiving means.

Further, according to an aspect of the present invention, the game device further includes means for obtaining display information about a method of displaying a spectator image, which shows a spectator of the sport, from means for storing the display information in association with the evaluation standard, the game operation evaluating means includes means for displaying the spectator image on a game screen, and the game operation evaluating means evaluates the game operation performed by the player by controlling display of the spectator image based on the result of the determination of the determining means and the display information that is associated with the evaluation standard.

Further, according to an aspect of the present invention, the spectator image shows one spectator or a plurality of the spectators, the game device further includes means for obtaining spectator count data, which is for a count of spectators shown in the spectator image, from means for storing the spectator count data, the display information includes information about a method of changing the spectator count data, and the game operation evaluating means controls the display of the spectator image by changing the count of spectators shown in the spectator image based on the result of the determination of the determining means and the display information that is associated with the evaluation standard.

Further, according to an aspect of the present invention, how the spectator image is displayed varies depending on who is a cheering subject of the one spectator or the plurality of the spectators, the game device further includes means for obtaining cheering subject data, which is about a cheering subject of the one spectator or the plurality of the spectators, from means for storing the cheering subject data, the display information includes information about a method of changing the cheering subject data, and the game operation evaluating means controls the display of the spectator image by changing the cheering subject of the one spectator or the plurality of the spectators based on the result of the determination of the determining means and the display information that is associated with the evaluation standard.

Further, according to an aspect of the present invention, how the spectator image is displayed varies depending on an attribute of the one spectator or attributes of the plurality of the spectators, the game device further includes means for obtaining spectator attribute data, which is about the attribute of the one spectator or the attributes of the plurality of the spectators, the one spectator or the plurality of the spectators having the player as a cheering subject, from means for storing the spectator attribute data, the display information includes information about a method of changing the spectator attribute data, and the game operation evaluating means controls the display of the spectator image by changing the attribute of the one spectator or the attributes of the plurality of the spectators, the one spectator or the plurality of the spectators having the player as a cheering subject, based on the result of the determination of the determining means and the display information that is associated with the evaluation standard.

Further, according to an aspect of the present invention, the moving object is moved in the game by a character which is operated by the player, the game device further includes means for obtaining information that indicates an attribute of the character operated by the player, from means for storing the information, and the game operation evaluating means evaluates the game operation performed by the player based on the result of the determination of the determining means and the information that indicates the attribute of the character operated by the player.

### BRIEF DESCRIPTION OF DRAWINGS

FIG. 1 A diagram illustrating the overall configuration of a game system according to the present invention.

FIG. 2 A diagram illustrating the hardware configuration of game devices according to embodiments of the present invention.

FIG. 3 A figure illustrating an example of a game space.

FIG. 4 A figure illustrating an example of a game screen that is displayed on a display unit.

FIG. 5 A figure illustrating challenging shots and safe shots.

FIG. 6 A figure illustrating an example of a game screen for a case where a ball is located in an area.

FIG. 7 A block diagram illustrating functions that are implemented by the game system.

FIG. 8 A figure illustrating a data storage example of evaluation standard data.

FIG. 9 A flow chart illustrating an example of processing executed in the game system.

FIG. 10 A flow chart illustrating the example of the processing executed in the game system.

FIG. 11 A figure illustrating an example of a game screen in Embodiment 2A.

FIG. 12 A figure illustrating a data storage example of spectator count data.

FIG. 13 A figure illustrating a data storage example of display information.

FIG. 14 A flow chart illustrating an example of different processing executed in the game system.

FIG. 15 A flow chart illustrating the example of the different processing executed in the game system.

FIG. 16 A figure illustrating an example of a game screen in Embodiment 2B.

FIG. 17 A figure illustrating a data storage example of cheering subject data.

FIG. 18 A figure illustrating another data storage example of the display information.

FIG. 19 A figure illustrating an example of a game screen in Embodiment 2C.

FIG. 20 A figure illustrating a data storage example of spectator attribute data.

FIG. 21 A figure illustrating still another data storage example of the display information.

FIG. 22 A figure illustrating a storage example of data that indicates character attributes.

FIG. 23 A figure illustrating the association between a character attribute and changing information.

### DESCRIPTION OF EMBODIMENTS

### 1. Embodiments

Embodiments of the present invention are described in detail below with reference to the drawings.

[1-1. Overall Configuration of a Game System]

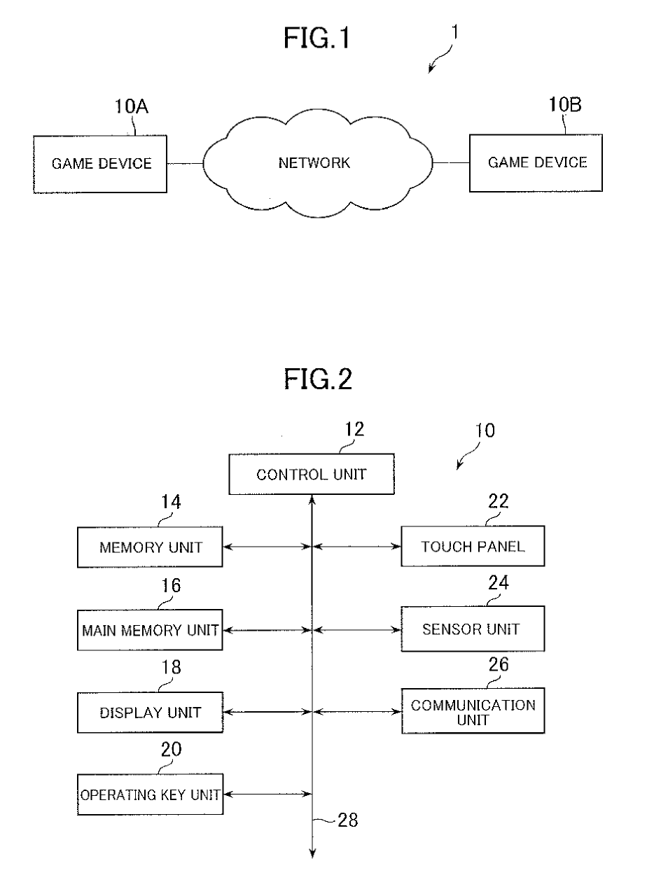

FIG. 1 is a diagram illustrating the overall configuration of a game system according to the present invention. As illustrated in FIG. 1, the game system which is denoted by 1 includes, for example, a plurality of game devices 10A and 10B (hereinafter collectively and simply referred to as game devices 10). The machines constituting the game system 1 are connected to each other via a network in a manner that allows data communication.

This embodiment describes a case of executing a sport video game that uses a moving object, in which two players compete with each other. One of the two players is hereinafter referred to as a “first player” and the other player is hereinafter referred to as a “second player”. The first player and the second player are collectively and simply referred to as players. The first player operates, for example, the game device 10A and the second player operates the game device 10B.

For example, one of the plurality of game devices 10 included in the game system 1 plays the role of a server that takes overall control of the game executed in the game system 1. Described below is a case where the game device 10A is assumed to be a game device which plays the role of the server.

The game device 10A first receives an operation performed by the player on the game device 10A. The game device 10A which plays the role of the server also receives data that indicates the specifics of an operation performed by the player from the game device 10B, which is the other game device. Based on the operations performed on the respective game devices 10, the game device 10A executes the game. The game device 10A which plays the role of the server further transmits the specifics of updates made to the various types of data relevant to the game to the game device 10B, which is the other game device, via a network.

On the other hand, when receiving the latest data, the game device 10B updates data that is stored in the game device 10B based on the received data. The game system 1 thus makes the various types of data relevant to the game consistent between the plurality of game devices 10.

The game system 1, which includes two game devices 10 in this embodiment to simplify the description, can include an arbitrary number of game devices 10.

[1-2. Hardware Configuration of the Game Devices]

FIG. 2 is a diagram illustrating the hardware configuration of the game devices according to the embodiments of the present invention. This embodiment describes a case where the game device 10A and the game device 10B have the same configuration. The game devices 10 are implemented by known computers. The game devices 10 described in this embodiment are implemented by portable terminals (for example, portable game machines or cellular phones), but the game devices 10 may be consumer game machines, arcade game machines, personal computers, or the like.

As illustrated in FIG. 2, the game devices 10 each include, among others, a control unit 12, a memory unit 14, a main memory unit 16, a display unit 18, an operating key unit 20, a touch panel 22, a sensor unit 24, and a communication unit 26, which are connected to one another via a bus 28, for example. The hardware configuration of the game devices 10 is not limited to the example of FIG. 2 and the game devices 10 may include various types of hardware included in known portable terminals (for example, an SD card slot and an optical disc reproducing unit).

The control unit 12 controls the components of the game device 10 based on an operating system stored in the memory unit 14, programs stored in various storage mediums which are connected externally (for example, an SD card), and various types of data obtained via the communication unit 26.

The memory unit 14 includes a non-volatile storage medium such as a flash memory. The memory unit 14 stores an operating system and the like. The main memory unit 16 includes a RAM, for example. A program and the like stored in the memory unit 14 are written into the main memory unit 16 as the need arises. The main memory unit 16 is also used as a work memory of the control unit 12.

The display unit 18 is one or more known monitors, e.g., liquid crystal display panels. The display unit 18 displays, for example, an image drawn in a VRAM (not shown). The operating key unit 20 is operating means provided for a user to input various operations, and includes a four-way navigation key, various buttons, and the like. The touch panel 22 is disposed so as to overlap with the display unit 18. The touch panel 22 transmits information about a point of external contact to the control unit 12.

The sensor unit 24 includes a CCD camera, a GPS sensor, a gyro sensor, an electronic compass (geomagnetic sensor), an acceleration sensor, and the like. The touch panel 22 and the sensor unit 24 may implement operating means which enables a user to perform various operations. The communication unit 26 exchanges data with an external device (e.g., the other game device 10B) via a network.

[1-3. Game Executed in the Game System]

The game system 1 executes a sport video game that uses a moving object. This embodiment describes a case of executing a golf game simulating a golf sport which uses a ball. The golf game is implemented by executing a program that is read out of the memory unit 14 or various storage media.

When the golf game is started, a game space representing an imaginary golf course is constructed in the main memory unit 16. Data indicating the game space is shared between the game devices 10A and 10B.

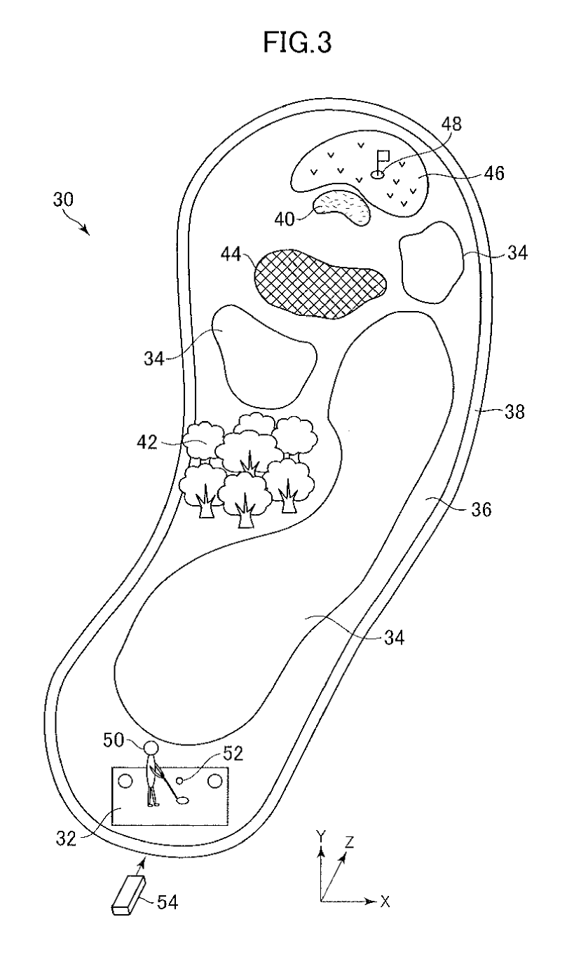

FIG. 3 is a figure illustrating an example of the game space. As illustrated in FIG. 3, objects such as a teeing ground 32, a fairway 34, rough 36, an OB zone 38, a bunker 40, a grove 42, a pond 44, a green 46, and a pin 48 are disposed in the game space which is denoted by 30. One of characters 50, a ball 52, and a virtual camera 45 are also put into the game space 30.

The character 50 shoots the ball 52 in response to a game operation performed by a player. The shot ball 52 moves within the game space 30. The player performs game operations while looking at a game screen that shows a view of the game space 30 from the virtual camera 45.

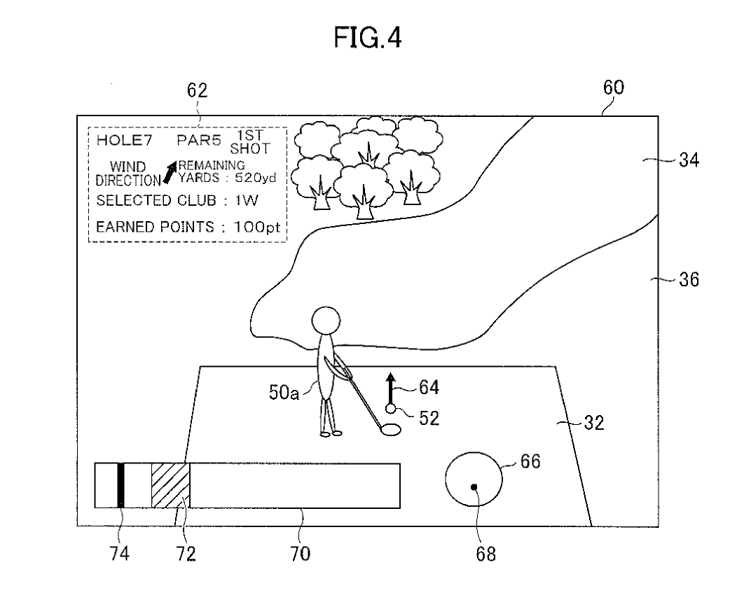

FIG. 4 is a figure illustrating an example of a game screen that is displayed on the display unit 18. This embodiment describes a case where a game screen 60 displayed on the game device 10A and a game screen 60 displayed on the game device 10B display the same data. As illustrated in FIG. 4, the game screen 60 displays objects that are included in the view field of the virtual camera 54.

The players play the game by operating the characters 50. In this case, the first player operates a first character 50a and the second player operates a second character 50b. The simple term “characters 50” is hereinafter used to refer to those characters collectively.

The players perform given game operations to cause the characters 50 to shoot and move a ball 52. The players aim to get the ball 52 into the pin 48 with fewer shots.

The order in which the characters 50 hit the ball 52 is determined by a given method. For instance, the player operating the character 50 whose ball 52 is farthest from the pin 48 performs a game operation for hitting the ball 52. In the situation of FIG. 4, it is the turn of the first character 50a to hit the ball 52. In this case, the first player performs a game operation to cause the first character 50a to hit the ball 52.

The game screen 60 also displays game information 62 which indicates the current situation of the game being executed. Displayed as the game information 62 are, for example, the hole number in the round, par, the current number of shots made by the character 50, the direction of the wind in the game space 30, the distance between the ball 52 and the pin 48, the club selected by the player, and points which the player has earned. The points increase or decrease in value based on the success or failure of a challenging shot or a safe shot which is described later. The points are, for example, an indicator of the result of an evaluation on a game operation performed by a player. When the points increase, for instance, the character 50 can have an increased ability value.

The player performs a given game operation to specify a direction in which the character 50 is to hit the ball 52 and the strength of the swing. The direction in which the character 50 is to hit the ball 52 is indicated by, for example, a direction indicator mark 64. The direction indicated by the direction indicator mark 64 changes to reflect the operation of the player.

A hit point at which the character 50 is to hit the ball 52 is indicated by, for example, a ball mark 66 and a hit point icon 68. The hit point icon 68 is displayed within the ball mark 66. The position of the hit point icon 68 changes to reflect the operation of the player. The angle at which the ball 52 shoots out and the curve of the shot vary depending on the position of the hit point icon 68.

The strength of the swing of the character 50 is indicated by, for example, a swing gauge 70. In other words, the swing gauge 70 is an area used by the player to specify the carry of the ball 52. The swing gauge 70 includes an impact zone 72 and a cursor 74.

The player performs a given game operation to move or stop the cursor 74 along the swing gauge 70. To which point the cursor 74 is moved or at which point the cursor 74 is stopped determines the strength and accuracy of the swing. For instance, a given game operation performed by the player causes the cursor 74 to move from an initial point (e.g., the left end of the swing gauge 70) in the rightward direction. When the cursor 74 moves further in the rightward direction, the swing of the character 50 is stronger. The player then performs a given game operation, causing the cursor 74 to move in the leftward direction. Lastly, the player performs a given game operation to stop the cursor 74.

In the case where the cursor 74 stops at a point inside the impact zone 72, for example, the player can hit the ball 52 at the hit point specified by the player (i.e., the hit point indicated by the hit point icon 68) and cause the ball 52 to hit with the strength indicated by the player, and in the direction specified by the player (i.e., the direction indicated by the direction indicator mark 64).

In the case where the cursor 74 stops at a point outside the impact zone 72, for example, the player cannot hit the ball 52 at the hit point specified by the player and cause the ball 52 to hit with the strength indicated by the player, and in the direction specified by the player. Specifically, the character 50 makes a missed shot in which the ball 52 curves in a direction that is not intended by the player or the character 50 makes an air shot.

The direction in which the ball 52 moves is determined based on various algorithms that are used in known golf games (e.g., a physical computing engine).

The game system 1 of this embodiment offers a choice of a challenging shot or a safe shot to the player when the moving start point of the ball 52 is inside an area set in the game space 30. A challenging shot or a safe shot is a shot for moving the ball 52 from the inside of this area along a given route. For example, it is more difficult to succeed in making a challenging shot than a safe shot. The player who has made a successful challenging shot or safe shot earns points.

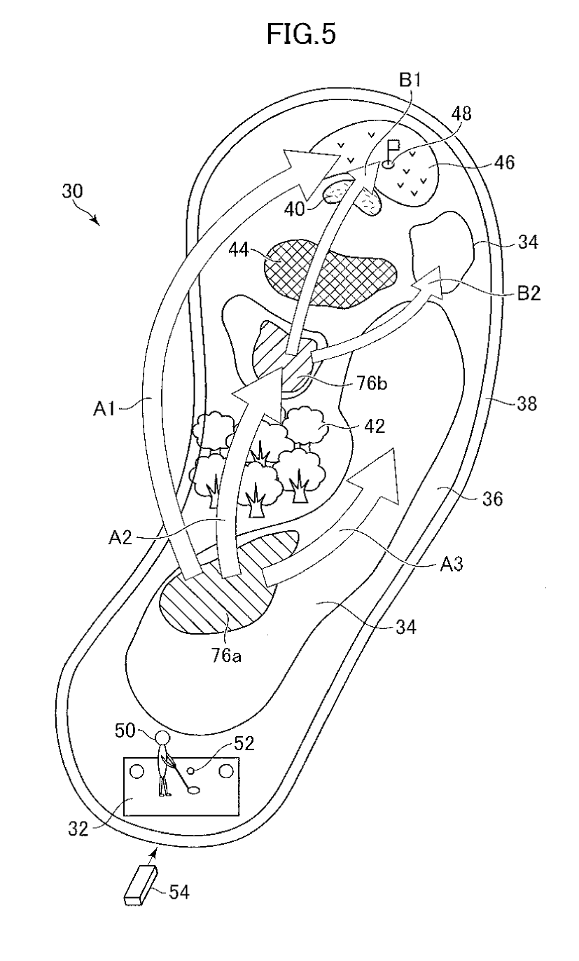

FIG. 5 is a figure illustrating challenging shots and safe shots. As illustrated in FIG. 5, two areas 76a and 76b (hereinafter those may also collectively and simply be referred to as areas 76), for example, are set in the game space 30. The area 76a is set in front of the grove 42, and the area 76b is set in front of the pond 44.

The player can make a challenging shot or a safe shot in the case where the ball 52 is located inside one of the areas 76. Set for the area 76a are, for example, challenging shots A1 and A2 which go over the grove 42, and a safe shot A3 which circumvents the grove 42. Set for the area 76a are, for example, a challenging shot B1 which goes over the pond 44 and a safe shot B2 which circumvents the pond.

When the ball 52 lands inside one of the areas 76, the game screen 60 presents guidance to the player on a challenging shot or a safe shot that is set for this area 76. The player selects the presented challenging shot or safe shot to specify what shot the character 50 is to make.

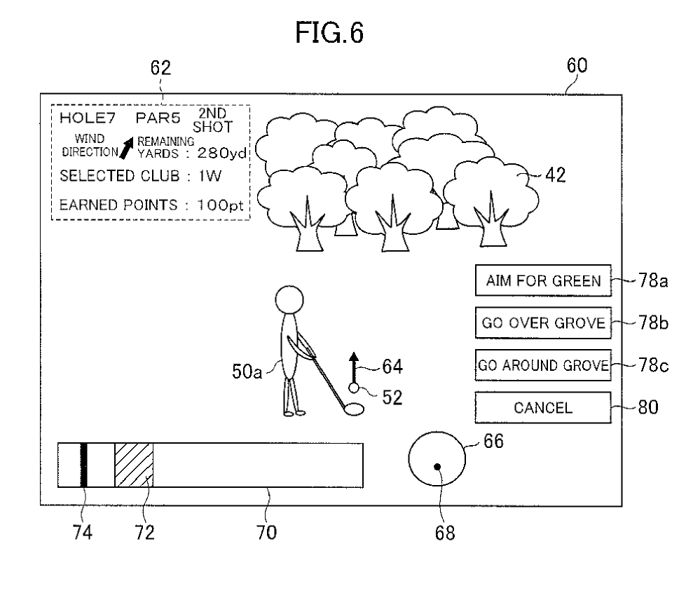

FIG. 6 is a figure illustrating an example of the game screen 60 for a case where the ball 52 is located inside the area 76a. As illustrated in FIG. 6, the game screen 60 displays guidance images 78a, 78b, and 78c (hereinafter those may also collectively and simply be referred to as guidance images 78). The guidance image 78a is guidance for the shot specifics of the challenging shot A1, the guidance image 78b is guidance for the shot specifics of the challenging shot A2, and the guidance image 78c is guidance for the shot specifics of the safe shot A3.

The player selects one of the guidance images 78 to specify what shot the character 50 is to make. In the case where the player wishes to make neither a challenging shot nor a safe shot, a “cancel” image 80 is selected.

The game system 1 is configured to increase the points of the player who has succeeded in making the challenging shot A1 or A2 or the safe shot A3 by an amount determined by what the successful shot has been. In other words, the game system 1 is configured to use other factors than the golf score in evaluating a game operation of a player. This technology is described below in detail.

[1-4. Functions Implemented by the Game System]

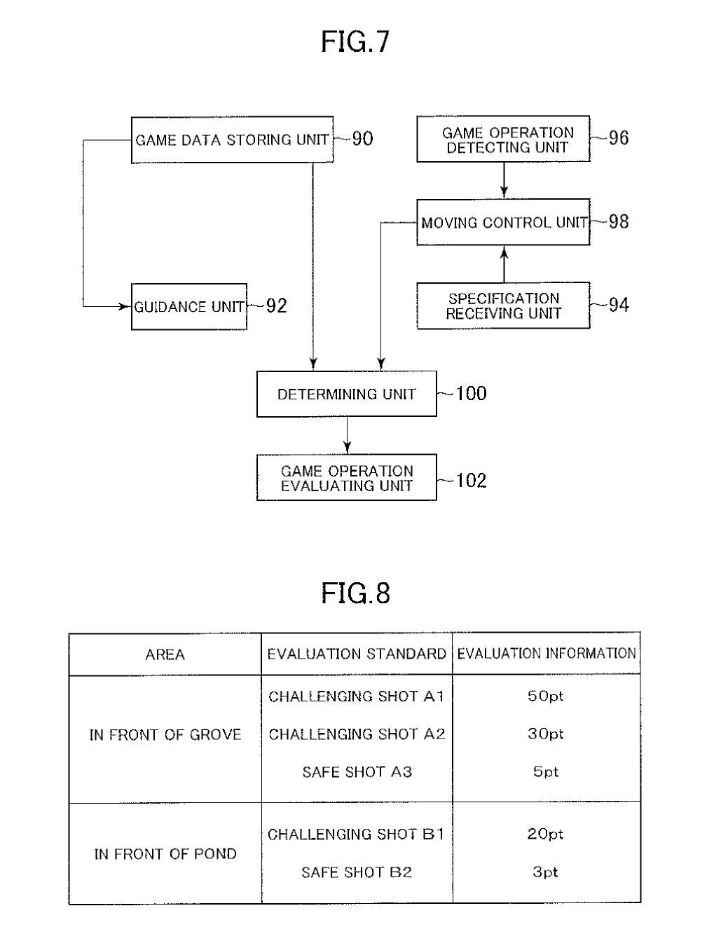

FIG. 7 is a block diagram illustrating functions that are implemented by the game system 1. As illustrated in FIG. 7, a game data storing unit 90, a guidance unit 92, a specification receiving unit 94, a game operation detecting unit 96, a moving control unit 98, a determining unit 100, and a game operation evaluating unit 102 are implemented in the game system 1. Functions described below are implemented by, for example, the control unit 12 of the game device 10 which plays the role of the server by operating as programmed by a program read out of the memory unit 14.

[1-4-1. Game Data Storing Unit]

The game data storing unit 90 is implemented mainly by the memory unit 14 and the main memory unit 16. The game data storing unit 90 stores various kinds of data necessary to execute the golf game.

The game data storing unit 90 stores, for example, game situation data about the current game situation, and parameter data indicating various parameters that are set in the golf game (e.g., the ability values of the characters 50 and course attributes).

Stored as the game situation data are, for example, information indicating, for each player, the moving start point of the ball (e.g., three-dimensional coordinates in the game space 30), information about the numbers of shots on each hole in the round, information about clubs selected by the players, information about the direction of the wind, and information for identifying a hole in the round.

The contents of the game situation data are updated by, for example, a player's game operation or a given algorithm. For instance, a game operation performed by a player causes an update to the contents of the game situation data. Specifically, when a shot made by one of the characters 50 moves the ball 52, the game situation data is updated.

The game data storing unit 90 also stores evaluation standard data which associates each area 76 in the game space 30 with an evaluation standard for evaluating the result of movement of a moving object (e.g., the ball 52) from a point inside the area 76.

The areas 76 are given areas within a range in which the ball 52 is allowed to move, and are set within the game space 30. The areas 76 are set in, for example, locations that satisfy a given positional relation with respect to objects disposed in the game space 30. In this embodiment, the area 76a is set on the fairway 34 that is in front of the grove 42, and the area 76b is set on the fairway 34 that is in front of the pond 44.

An evaluation standard is the result of movement of the ball 52 to be moved by a player from one of the areas 76, and indicates a given method of moving the ball 52 from the area 76. For example, an evaluation standard indicates a standard for at least one of the moving path of the ball 52 from a point inside the area 76, the arrival point, the moving direction, the moving speed, and the moving distance.

An example of information stored as an evaluation standard is information indicating the moving path of the ball 52 to be moved by a player (e.g., three-dimensional coordinates or a numerical expression of a parabola). In this embodiment, the area 76a is associated with information indicating the trajectories of the challenging shots A1 and A2 and the safe shot A3, and the area 76b is associated with information indicating the trajectories of the challenging shot B1 and the safe shot B2.

This embodiment describes a case where the evaluation standard data associates an evaluation standard with evaluation information about a method of evaluating a game operation performed by a player (evaluation specifics). The evaluation information is information for determining the specifics of an evaluation on a game operation performed by a player, for example, information indicating how high or low an evaluation is passed on the player. The evaluation information in a case described in this embodiment is points given to the player.

FIG. 8 is a figure illustrating a data storage example of the evaluation standard data. As illustrated in the example of FIG. 8, each area 76 is associated with an evaluation standard and evaluation information. Information indicating a given area in the fairway 34 or the rough 36 (e.g., three-dimensional coordinates set in the game space 30) is stored as information about the area 76.

Stored as information about an evaluation standard is, for example, information indicating the moving path (trajectory) of a challenging shot or a safe shot. Stored as evaluation information is information indicating how many points are given to a player who succeeds in making a challenging shot or a safe shot. The evaluation standard data in this embodiment may be designed so as to set how many points are to be subtracted when a challenging shot or a safe shot fails.

The control unit 12 functions as means for obtaining various types of data (e.g., the game situation data and the parameter data) stored in the game data storing unit 90. The control unit 12 also functions as means for updating various types of data (e.g., the game situation data and the parameter data) stored in the game data storing unit 90. Data stored in the game data storing unit 90 is not limited to those of the above-mentioned example, and can be any type of data as long as the data is necessary for the game devices 10 to execute the golf game.

[1-4-2. Guidance Unit]

The guidance unit 92 is implemented mainly by the control unit 12 and the display unit 18. The guidance unit 92 presents guidance to the player on an evaluation standard that is associated with the area 76 that contains a moving start point. The moving start point is the current location of the ball 52 and refers to a point from which the ball 52 is to move. The guidance unit 92 presents to the player guidance on an evaluation standard by, for example, displaying the guidance image 78 that shows the specifics of the evaluation standard on the game screen 60.

How the guidance unit 92 presents guidance is not limited to the example in which an image is used. To give another example, the guidance unit 92 may present audio guidance on an evaluation standard.

The guidance unit 92 may also present guidance on an evaluation standard before or after a game operation performed by the player is detected. In the former case, the player performs a game operation for causing the character 50 to make a shot with the knowledge of an evaluation standard presented by the guidance unit 92. In the latter case, the player is made aware of an evaluation standard after performing a game operation. In other words, after causing the character 50 to make a shot, the player is made aware that the shot has been evaluated based on an evaluation standard.

[1-4-3. Specification Receiving Unit]

The specification receiving unit 94 is implemented mainly by the control unit 12 and the operating key unit 20. The specification receiving unit 94 receives specification from the player (e.g., the first player), an opponent of the player (e.g., the second player), or a user watching the game about an evaluation standard associated with an area that contains the moving start point. A user watching the game is, for example, a user who is one of the users operating the game devices 10 that are included in the game system 1 and who is watching on the game screen 60 the game played by the first player and the second player.

For instance, the specification receiving unit 94 receives the specification of one of evaluation standards that are presented by the guidance unit 92 before the player performs a game operation (i.e., before the player causes the character 50 to make a shot). This embodiment describes a case where the player who causes the character 50 to make a shot specifies an evaluation standard. The specification receiving unit 94 receives specification of an evaluation standard by, for example, receiving a choice from among the guidance images 78.

[1-4-4. Game Operation Detecting Unit]

The game operation detecting unit 96 is implemented mainly by the control unit 12 and the operating key unit 20. The game operation detecting unit 96 detects a game operation performed by a player. For instance, the game operation detecting unit 96 detects a game operation based on a detection signal from operating means (e.g., the operating key unit 20) which enables a player to perform a game operation. A game operation is performed by, for example, the pressing of a given button of the operating key unit 20 by a player.

This embodiment describes a case where the game operation detecting unit 96 detects a game operation performed by the player after the specification receiving unit 94 receives specification of an evaluation standard. Specifically, a game operation for causing the character 50 to make a shot is received after an evaluation standard is selected with the use of the guidance images 78.

[1-4-5. Moving Control Unit]

The moving control unit 98 is implemented mainly by the control unit 12. The moving control unit 98 moves a moving object (e.g., the ball 52) from a moving start point based on the result of detection by the game operation detecting unit 96 (i.e., a game operation performed by the player). The ball 52 is moved based on, for example, the player's game operation and a moving method defined by the game program. The moving control unit 98 moves the ball 52 from a moving start point by updating the moving start point of the ball 52 that is stored in the game situation data.

For instance, the moving control unit 98 determines the result of movement of the ball 52 by calculating, based on the player's game operation, at least one of the moving path, arrival point, moving direction, moving speed, and moving distance of the ball 52. Information indicating the moving path of the ball 52 (e.g., three-dimensional coordinates in the game space 30), for example, is stored temporarily in the game data storing unit 90. In the case where the arrival point of the ball 52 is in the OB zone 38, for example, the ball 52 does not move to this arrival point and returns to its original location.

[1-4-6. Determining Unit]

The determining unit 100 is implemented mainly by the control unit 12. The determining unit 100 determines whether or not the result of a move of a moving object (e.g., the ball 52) from a moving start point satisfies an evaluation standard associated with the area 76 that contains the moving start point.

This embodiment describes a case where the determining unit 100 determines whether or not the result of movement of a moving object (e.g., the ball 52) from a moving start point satisfies an evaluation standard presented by the guidance unit 92. In other words, the result of movement is compared against only evaluation standards presented by the guidance unit 92 out of evaluation standards stored in the evaluation standard data.

The determining unit 100 also determines, for example, whether or not the result of movement of a moving object (e.g., the ball 52) from a moving start point satisfies a specified evaluation standard which is received by the specification receiving unit 94. In other words, the result of movement is compared against, for example, only a specified evaluation standard received by the specification receiving unit 94 out of evaluation standards stored in the evaluation standard data.

This embodiment describes a case where the determining unit 100 determines whether or not at least one of the moving path of a moving object (e.g., the ball 52) from a moving start point, the arrival point, the moving direction, the moving speed, and the moving distance satisfies an evaluation standard associated with the area 76 that contains the moving start point.

For instance, the determining unit 100 compares the result of movement of the ball 52 from a moving start point by the moving control unit 98 against an evaluation standard associated with the relevant area 76, and obtains the amount of deviation between the two. For instance, the amount of deviation to be obtained shows deviation between the moving path of the ball 52 indicated by an evaluation standard and the moving path obtained by the moving control unit 98. The determining unit obtains, for example, the amount of deviation between three-dimensional coordinates that are indicated by an evaluation standard stored in the evaluation standard data and three-dimensional coordinates that have been calculated by the moving control unit 98.

Whether or not the evaluation standard is satisfied is determined based on, for example, whether or not the deviation amount obtained by the determining unit 100 is within a given range. In the case where the deviation amount is within the given range, for example, it is determined that the evaluation standard is satisfied, namely, that a challenging shot or a safe shot by the player has succeeded.

How the determining unit 100 determines is not limited to the method described above which uses the amount of deviation. The determining unit 100 only needs to determine whether or not an evaluation standard is satisfied based on information about the result of a comparison between the actual moving result of the ball 52 and a moving result that is indicated by the evaluation standard.

[1-4-7. Game Operation Evaluating Unit]

The game operation evaluating unit 102 is implemented mainly by the control unit 12. The game operation evaluating unit 102 evaluates a game operation performed by a player based on the result of determination by the determining unit 100. A game operation is evaluated by, for example, executing processing of updating the game situation data, or various types of effect processing.

This embodiment describes a case where, when the result of movement of a moving object (e.g., the ball 52) from a moving start point satisfies an evaluation standard associated with the area 76 that contains the moving start point, the game operation evaluating unit 102 evaluates the player's game operation based on evaluation information that is associated with the evaluation standard. In the case where the player's game operation is a success, for example, points associated with the evaluation standard are given to the player. In the case where the player's game operation is a failure, for example, no points are given to the player.

[1-5. Processing Executed in the Game System]

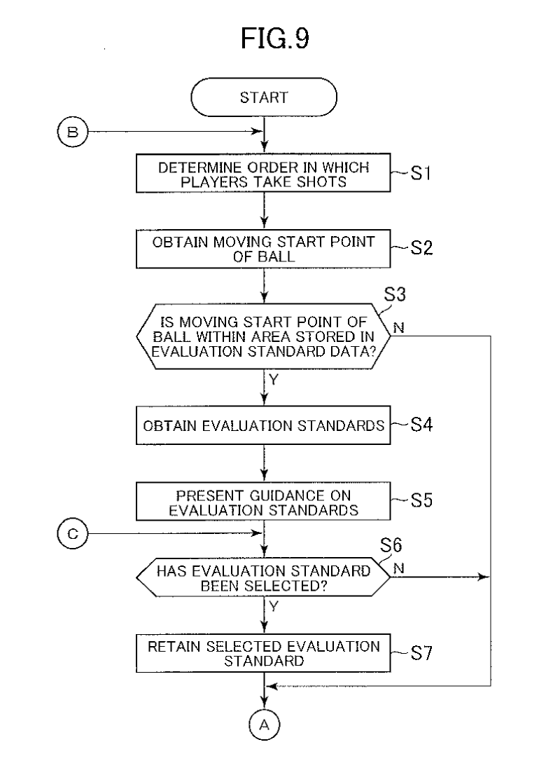

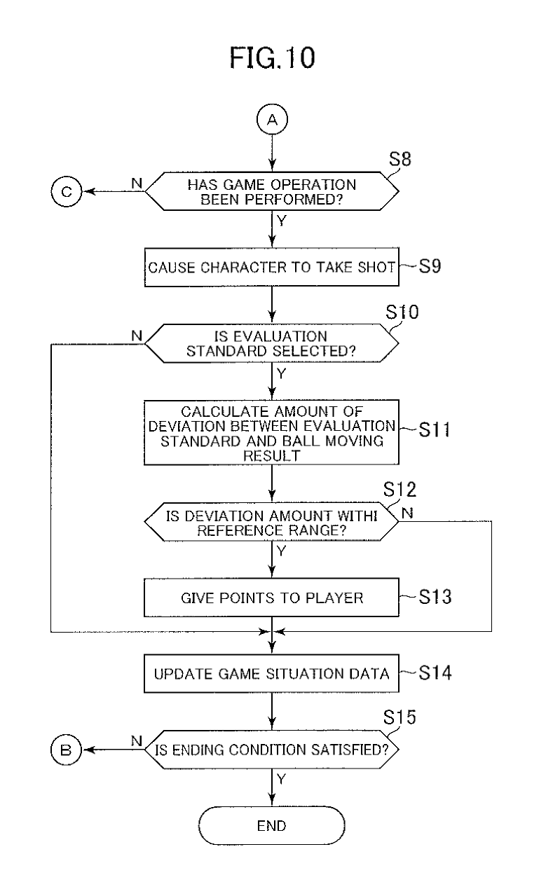

FIGS. 9 and 10 are flow charts illustrating an example of processing that is executed in the game system 1. The operation of the game device 10 that plays the role of the server (e.g., the game device 10A) is described here. The processing of FIGS. 9 and 10 is executed by the control unit 12 by operating as programmed by a program that is read out of the memory unit 14.

As illustrated in FIG. 9, the control unit 12 first refers to the game situation data to determine the order in which the players make shots (S1). In S1, the order in which the players make shots is determined by identifying a player whose ball 52 is farthest from the pin 48.

The control unit 12 obtains the moving start point of the ball 52 of the player whose turn to make a shot has arrived (S2). The control unit 12 determines whether or not the moving start point of the ball 52 is within the area 76 that is stored in the evaluation standard data (S3). For instance, the control unit 12 determines whether or not three-dimensional coordinates indicating the moving start point of the ball 52 are contained in the area 76 that is stored in the evaluation standard data.

When it is not determined that the moving start point of the ball 52 is within the area 76 (S3: N), the processing proceeds to S8 which is described later.

When it is determined that the moving start point of the ball 52 is within the area 76 (S3: Y), the control unit 12 obtains evaluation standards that are associated with this area 76 (S4). For instance, the control unit 12 obtains information indicating the moving path of a challenging shot or a safe shot.

The control unit 12 presents guidance on the evaluation standards obtained in S4 (S5). Specifically, the guidance images 78 which are guidance for the evaluation standards are displayed on the game screen 60.

The control unit 12 determines whether or not the player has selected any one of the evaluation standards (S6). Specifically, the control unit 12 determines whether or not the player has performed a touching operation or the like that specifies one of the guidance images 78 which are guidance for the evaluation standards. When it is determined that the player has selected one of the evaluation standards (S6: Y), the control unit 12 retains the evaluation standard selected by the player (S7). Specifically, information that identifies the evaluation standard selected by the player is stored in the main memory unit 16 or the like.

When it is not determined that the player has selected any one of the evaluation standards (S6: N), the processing of S7 is not executed. In other words, when the “cancel” image 80 is selected, information that identifies an evaluation standard selected by the player is not stored in the main memory unit 16 or the like, or information indicating that the player has not specified an evaluation standard is stored in the main memory unit 16 or the like.

The control unit 12 determines whether or not the player has performed a game operation (S8). In S8, whether or not a given button of the operating key unit 20 has been pressed is determined to determine whether or not an operation for causing the character 50 to start a swing has been performed.

When it is not determined that the player has performed a game operation (S8: N), the processing returns to S6 in order to determine again whether or not an evaluation standard has been selected.

When it is determined that the player has performed a game operation (S8: Y), the control unit 12 causes the character 50 to make a shot based on the player's game operation (S9). In S9, animation processing that causes the character 50a to swing on the game screen 60 is executed.

The cursor 74 moves along the swing gauge 70 in response to the game operation of the player. The result of movement of the ball 52 is calculated based on the cursor movement. For instance, the trajectory and arrival point of the ball 52 are calculated based on a direction indicated by the direction indicator mark 64, an angle indicated by the hit point icon 68, and the strength of the swing indicated by the swing gauge.

The control unit 12 determines whether or not there is an evaluation standard that has been selected (S10). The determination in S10 is executed by, for example, preparing a flag that indicates whether or not one of the guidance images 78 showing evaluation standards has been selected in S6.

When it is not determined that there is an evaluation standard that has been selected (S10: N), the processing proceeds to S14 which is described later.

When it is determined that there is an evaluation standard that has been selected (S10: Y), the control unit 12 compares the result of the movement of the ball 52 against the evaluation standard specified by the player, to thereby calculate the amount of deviation between the two (S11). Specifically, the control unit 12 calculates the amount of deviation between a trajectory that is indicated by the evaluation standard of the evaluation standard data and the trajectory of the ball 52 that has been calculated in S9. For example, the difference in three-dimensional coordinates between the trajectories is calculated as the amount of deviation.

The control unit 12 determines whether or not the deviation amount calculated in S11 is within a reference range (S12). Specifically, the control unit 12 determines whether or not the trajectory of the ball 52 moved by the shot of the character 50 is close to the trajectory of a challenging shot or a safe shot.

When it is determined in S12 that the calculated deviation amount is within the reference range (S12: Y), the control unit 12 gives points defined in the evaluation standard data to the player who has succeeded in making a challenging shot or a safe shot (S13). When it is not determined in S12 that the calculated deviation amount is within the reference range (S12: N), the processing of S13 is not executed and no points are given to the player.

The control unit 12 updates the game situation data (S14). For instance, the location of the ball 52 is updated based on the arrival point of the ball 52 that has been calculated in S9. The sum total of points earned by the player, for example, is also updated based on the points given to the player in S13. Information indicating the number of shots of the player, for example, is updated as well.

The control unit 12 determines whether or not an ending condition is satisfied (S15). The ending condition is a condition for ending this processing, and can be a predetermined condition. The ending condition is, for example, whether or not an operation for ending the game has been input, or whether or not a hole out has occurred.

When it is not determined that the ending condition is satisfied (S15: N), the processing returns to S1. When it is determined that the ending condition is satisfied (S15: Y), the processing is ended.

According to the game system 1 described above, depending on whether the ball 52 is inside one of the areas 76 or not, a player is allowed to select whether to make a challenging shot or a safe shot, or neither. The game system 1 is further capable of giving points to a player depending on whether the challenging shot or safe shot of the player has been a success or not.

The development of the specifics of play by a player (e.g., the strategic properties of a shot) can thus be evaluated as well, instead of simply evaluating a game operation of a player by the golf score. Specifically, while a difficult shot and a simple shot are both counted as one shot for the score, evaluating the specifics of a shot as in this embodiment ensures that the specifics of play are reflected in an evaluation. In other words, evaluation processing that satisfies players is accomplished, and the fun of the game is improved.

In addition, evaluating a game operation performed by a player based on an evaluation method that is associated with an evaluation standard varies the specifics of the evaluation depending on the specifics of a shot tried by the player. This makes it possible, for example, to give a higher evaluation to a player who tries a more difficult shot.

The game system 1 can also present guidance to the player on whether a challenging shot or a safe shot is to be made by the character 50 under control of the player by displaying the guidance images 78 on the game screen 60. The player can specify one of the guidance images 78, which allows the player to determine whether to make a challenging shot or a safe shot, or neither.

### 2. Embodiment 2

Embodiment 1 has described a case where a player is evaluated by giving points to the player when the ball 52 is located inside one of the areas 76 and the player succeeds in making a challenging shot or a safe shot. How a player who makes a challenging shot or a safe shot is evaluated is not limited to the example of Embodiment 1. The specifics of a shot may be evaluated by other evaluation methods.

In Embodiment 2, a spectator image showing spectators are displayed on the game screen 60, and a game operation performed by a player is evaluated by changing how the spectator image is displayed when the player succeeds in making a challenging shot or a safe shot.

The configuration of the game system 1, the hardware configuration of the game devices 10, and functional block diagrams in Embodiment 2 are the same as in the first embodiment, and descriptions thereof are therefore omitted.

The game data storing unit 90 of Embodiment 2 stores display information, which is about a method of displaying a spectator image showing spectators of a sport (e.g., golf), in association with an evaluation standard. The spectator image displaying method is what is displayed as a spectator image or the display mode of a spectator image, and indicates, for example, at least one of the number of spectators shown in the spectator image, the shape (silhouette), the pattern, the color, the size, and the luminance.

The game operation evaluating unit 102 of Embodiment 2 includes means for displaying a spectator image on the game screen 60, and evaluates a game operation performed by a player by controlling the display of the spectator image based on the result of determination by the determining unit 100 and on the display information that is associated with an evaluation standard. In short, a spectator image is displayed on the game screen 60 based on a display method that is indicated by the display information. Image data of a spectator image is stored in the game data storing unit 90 in advance.

Described here is a case where a game operation is evaluated by controlling the display of a spectator image in the manners of the following Embodiments 2A to 2C.

### 2-1. Embodiment 2A

In Embodiment 2A, display is controlled so that, for example, spectators who cheer for a player (fans of the player) increase in number when the player succeeds in making a challenging shot or a safe shot.

### 2-1-1. Functions Implemented in Embodiment 2A

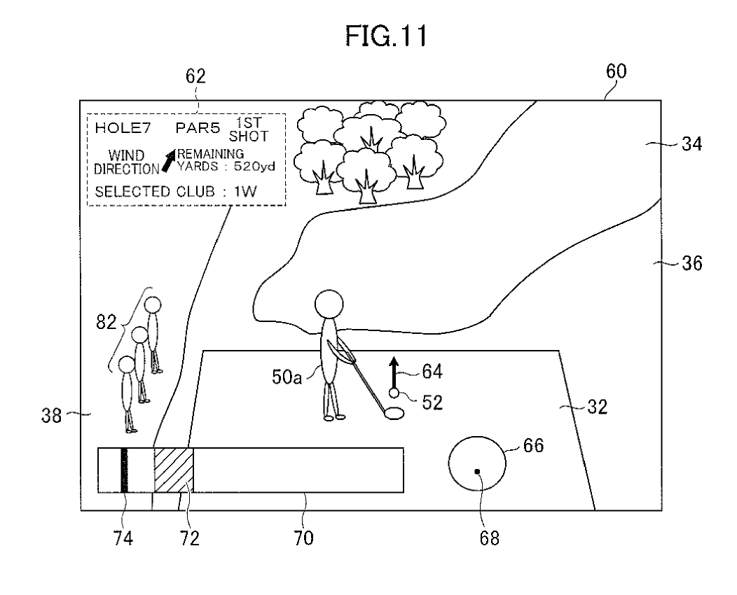

FIG. 11 is a figure illustrating an example of the game screen 60 in Embodiment 2A. A spectator image 82 is displayed in, for example, the OB zone 38 on the game screen 60. Embodiment 2A describes a case where the spectator image 82 shows one spectator or a plurality of spectators. The game screen 60 of FIG. 11 displays, for example, the spectator image 82 that shows three spectators who cheer for the player. The number of spectators shown in the spectator image 82 varies depending on, for example, the result of a challenging shot or safe shot made by the player.

Embodiment 2A describes a case where the game data storing unit 90 stores spectator count data which is about the number of spectators shown in the spectator image 82. In other words, the spectator count data indicates the number of spectators who cheer for the player.

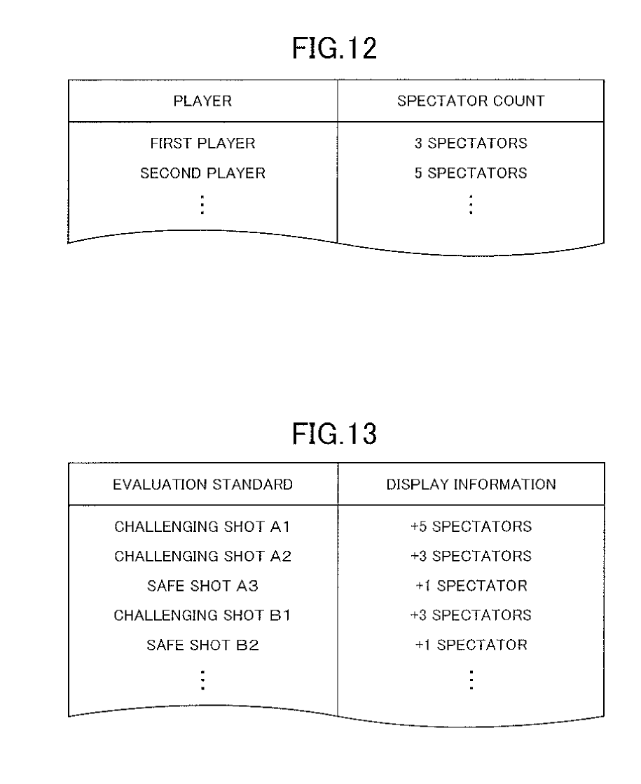

FIG. 12 is a figure illustrating a data storage example of the spectator count data. As illustrated in FIG. 12, information indicating a player is associated with information about the number of spectators who cheer for the player. For example, the number of spectators who cheer for the player increases when the player succeeds in making a challenging shot or a safe shot. The spectator count data may be set so that the number of spectators who cheer for the player decreases when the player fails in making a challenging shot or a safe shot. Accordingly, the spectator count data can also be said to be data that indicates the past evaluation results of game operations performed by the player.

Embodiment 2A describes a case where the display information includes information about a method of changing the spectator count data. The spectator data changing method indicates how much the spectator count that is indicated by the spectator count data is changed. In other words, the display information defines how many spectators are to be added or subtracted depending on the result of determination of the determining unit 100.

FIG. 13 is a figure illustrating a data storage example of the display information. Stored as the display information is, for example, information about how many spectators are to be added when a challenging shot or a safe shot succeeds. For instance, the number of spectators who cheer for the player increases when the player succeeds in making a challenging shot or a safe shot. The display information may be set so that the number of spectators who cheer for the player decreases when the player fails in making a challenging shot or a safe shot. How many spectators are to be added or subtracted varies depending on what challenging shot or safe shot the player has succeeded or failed in making.

Embodiment 2A describes a case where the game operation evaluating unit 102 controls the display of the spectator image 82 by changing the number of spectators shown in the spectator image 82 based on the result of determination of the determining unit 100 and on the display information that is associated with an evaluation standard. In other words, the spectator count indicated by the spectator count data is changed and the spectator image 82 is updated accordingly.

In the case where the determining unit 100 has determined that an evaluation standard is satisfied, for example, the number of spectators shown in the spectator image 82 increases. In the opposite case, where the determining unit 100 has not determined that an evaluation standard is satisfied, for example, the number of spectators shown in the spectator image 82 decreases.

### 2-1-2. Processing Executed in Embodiment 2A

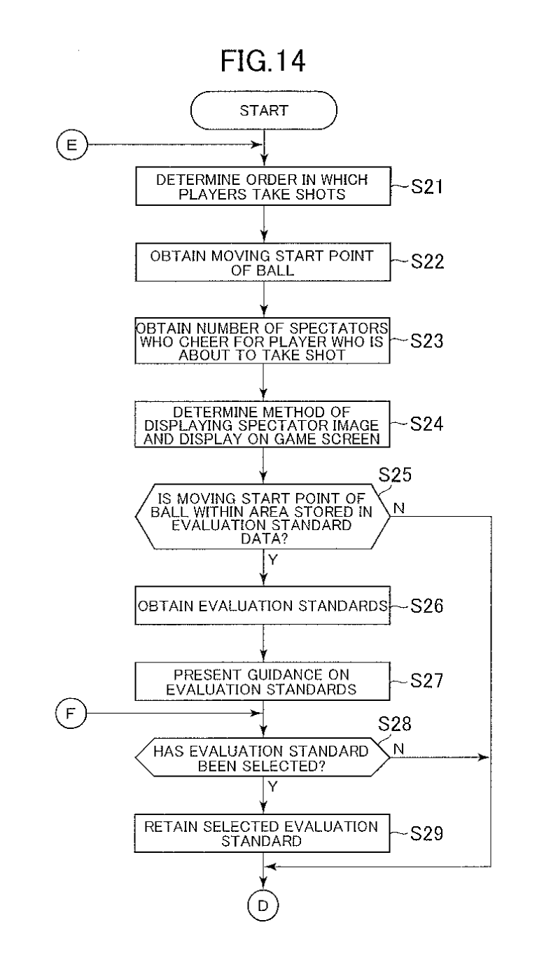

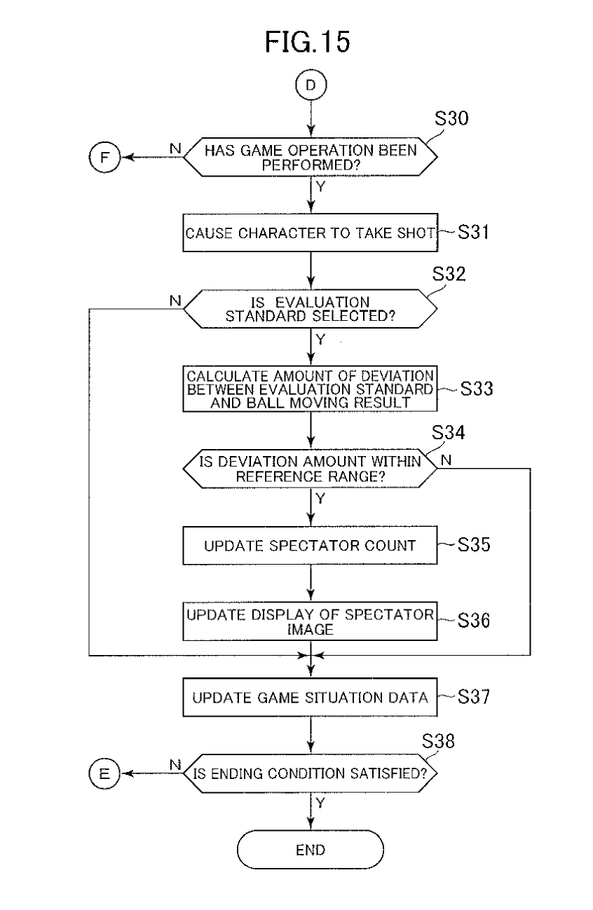

FIGS. 14 and 15 are flow charts illustrating an example of processing that is executed in the game system 1. The operation of the game device 10 that plays the role of the server (e.g., the game device 10A) is described here. The processing of FIGS. 14 and 15 is executed by the control unit 12 by operating as programmed by a program that is read out of the memory unit 14.

As illustrated in FIGS. 14, S21 and S22 are the same as S1 and S2, respectively, and descriptions thereof are therefore omitted.

The control unit 12 refers to the spectator count data to obtain the number of spectators who cheer for a player who makes a shot (S23). The control unit 12 determines a display method of the spectator image 82 based on the spectator count obtained in S23, and displays the spectator image 82 on the game screen 60 (S24). For instance, the spectator image 82 of spectators who cheer for a player whose turn to make a shot has arrived is displayed on the game screen 60 so as to include as many spectators as the spectator count obtained in S23.

Steps S25 to S34 which follow are the same as S3 to S12, respectively, and descriptions thereof are omitted.

The control unit 12 updates the number of spectators who cheer for the player based on information about how many spectators are to be added or subtracted by the change that is associated with the evaluation standard (S35).

The control unit 12 updates the display of the spectator image 82 on the game screen 60 based on the spectator count updated in S35 (S36). In the case where the player has succeeded in making a challenging shot or a safe shot, for example, the number of spectators in the spectator image 82 who cheer for the player increases. In the opposite case, where the player fails in making a challenging shot or a safe shot, for example, the number of spectators in the spectator image 82 who cheer for the player decreases.

Steps S37 and S38 which follow are the same as S14 and S15, respectively, and descriptions thereof are therefore omitted.

According to the game system 1 of Embodiment 2A, when a player makes a challenging shot or a safe shot, the number of spectators shown in the spectator image 82 can be changed based on the result of the challenging shot or the safe shot. The player thus easily understands that the game system 1 really evaluates the specifics of play using the specifics of a shot instead of evaluating the specifics of play using the golf score.

Only the spectator image 82 of spectators who cheer for a player who is about to make a shot is displayed in the case described above, but the spectator image 82 that shows spectators who cheer for the other player or spectators who do not cheer for any of the players may be displayed in Embodiment 2A.

In this case, when the first player succeeds in making a challenging shot or a safe shot, for example, the display of a spectator image 82a is controlled so that only the spectators who cheer for the first player increase in number. When the second player succeeds in making a challenging shot or a safe shot, on the other hand, the display of a spectator image 82b is controlled so that only the spectators who cheer for the second player increase in number. Controlling display in this manner makes it easy for every player to keep track of increases or decreases in the number of spectators who cheer for the player.

### 2-2. Embodiment 2B

In Embodiment 2A, when a player succeeds in making a challenging shot or a safe shot, only the number of spectators who cheer for the player increases or decreases. Alternatively, the spectator images 82 may be changed so that spectators who have cheered for the other player cheer for the current player.

For instance, in Embodiment 2B, a cheering subject is set for each spectator shown in the spectator images 82, and when a player succeeds in making a challenging shot or a safe shot, the cheering subject of the spectator changes. A cheering subject set for a spectator is a player (e.g., the first player) or an opponent (e.g., the second player) that is associated with a spectator shown in one of the spectator images 82. The display method of each spectator image 82 in Embodiment 2B is varied depending on the cheering subject of the spectator.

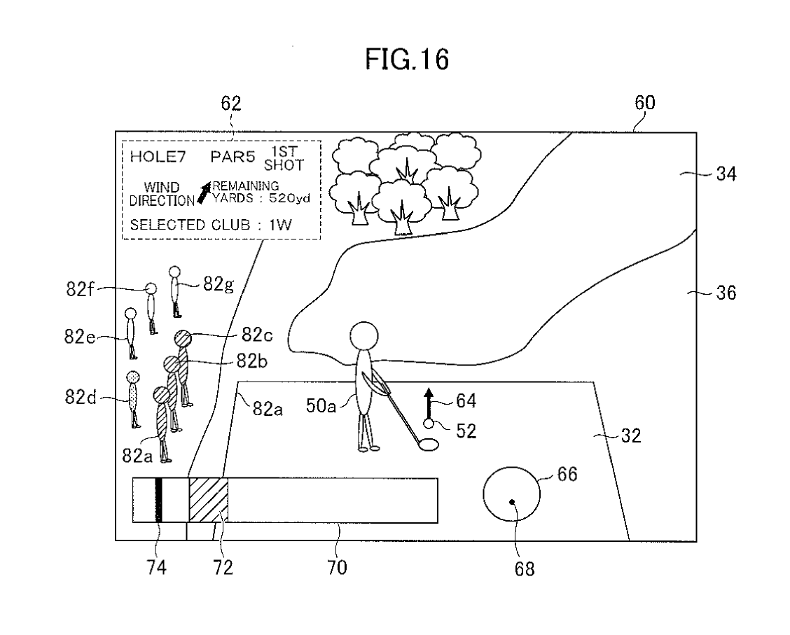

FIG. 16 is a figure illustrating an example of the game screen 60 in Embodiment 2B. Spectator images 82a, 82b, and 82c (in red, for example) show spectators who cheer for the first player, for example. A spectator image 82d (in blue, for example) shows a spectator who cheers for the second player, for example. Spectator images 82e, 82f, and 82g (in white, for example) show neutral spectators who cheer for neither the first player nor the second player, for example.

When the first player succeeds in making a challenging shot or a safe shot, for example, the spectator who has cheered for the second player or the neutral spectators are changed so as to cheer for the first player. Specifically, by updating the display of the spectator image 82d or the spectator images 82e, 82f, and 82g, the spectator who has cheered for the second player is changed so as to cheer for the first player or the spectators who have been neutral are changed so as to cheer for the first player.

When the first player fails in making a challenging shot or a safe shot, for example, the spectators who have cheered for the first player now cheer for the second player or become neutral. Specifically, the display of the spectator images 82a, 82b, and 82c is updated so that the spectators who have cheered for the first player now cheer for the second player or become neutral.

### 2-2-1. Functions Implemented in Embodiment 2B

Embodiment 2B describes a case where the game data storing unit 90 stores cheering subject data about a cheering subject of a spectator.

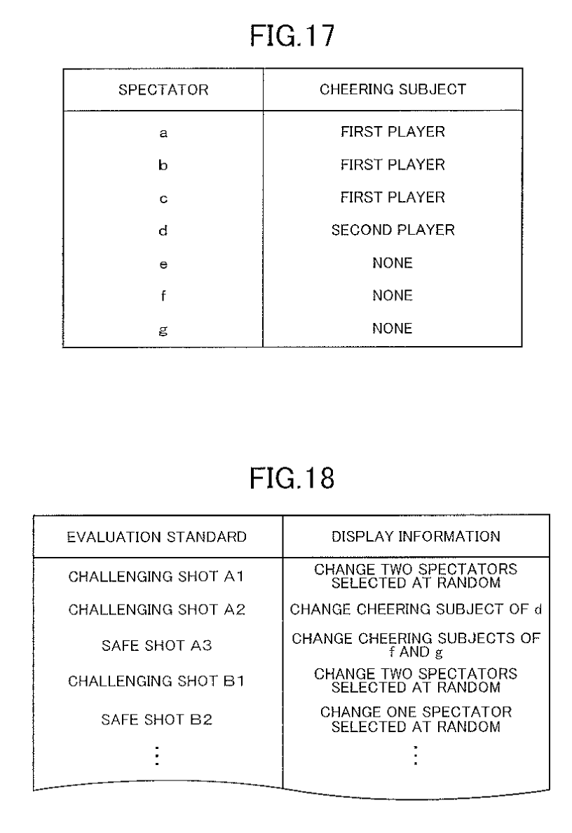

FIG. 17 is a figure illustrating a data storage example of the cheering subject data. As illustrated in FIG. 17, information for identifying a spectator and information indicating a cheering subject of the spectator are associated with each other. In this embodiment, for example, a cheering subject is set for each of seven spectators a, b, c, d, e, f, and g. The cheering subject of the spectators a, b, and c is the first player and the cheering subject of the spectator d is the second player. No cheering subjects are set for the spectators e, f, and g. The cheering subject of a spectator changes when, for example, a player succeeds or fails in making a challenging shot or a safe shot.

Embodiment 2B describes a case where the display information includes information about a method of changing the cheering subject data. In other words, the display information indicates a method of changing the cheering subject of a spectator.

FIG. 18 is a figure illustrating another data storage example of the display information. The display information defines how the cheering subject of a spectator is changed when, for example, a challenging shot succeeds. For instance, when the first player succeeds in making a challenging shot, the first player is set as a cheering subject for two spectators selected at random from among the spectators for which no cheering subjects have been set.

Embodiment 2B describes a case where the game operation evaluating unit 102 controls the display of the spectator images 82 by changing the cheering subjects of the spectators based on the result of determination of the determining unit 100 and on the display information that is associated with an evaluation standard. In short, the spectator images 82 are displayed on the game screen 60 based on cheering subjects that are indicated by the changed cheering subject data.

In the case where the determining unit 100 has determined that the evaluation standard is satisfied, for example, the spectator images 82 are changed so that the spectator who has cheered for the other player or the neutral spectators now cheers for the current player. In the opposite case where the determining unit 100 has not determined that the evaluation standard is satisfied, for example, the spectator images 82 are changed so that the spectators who have cheered for the current player change to spectators who cheer for the other player or to neutral spectators.

### 2-2-2. Processing Executed in Embodiment 2B

The same processing as in FIGS. 14 and 15 is executed in Embodiment 2B. However, in S23, the cheering subjects of respective spectators are identified by referring to the cheering subject data and, in S24, the spectator images 82 are displayed on the game screen 60 based on the identified cheering subjects.

In S35, the cheering subject data is updated based on cheering subject changing methods of the spectators that are associated with the challenging shot or the safe shot. In S36, the display of the spectator images 82 on the game screen 60 is updated based on the cheering subjects updated in S35. In the case where a player succeeds in making a challenging shot or a safe shot, for example, spectators who have not cheered for the player newly cheer for the player. In the opposite case, where a player fails in making a safe shot, for example, spectators who have cheered for the player now cheer for the other player.

The game system 1 of Embodiment 2B allows a player who succeeds in making a challenging shot or a safe shot to feel as though given spectators have become fans of the player as a result of the challenging shot or the safe shot.

In Embodiment 2B, the display method of the spectator image 82 of interest may be varied depending on the time when a cheering subject has been set for a spectator shown by the spectator image 82. For instance, the spectator image 82 may be given a higher luminance when the time elapsed since the player has been set as the cheering subject is longer. This way, the player can know whether a spectator that is shown by one of the spectator images 82 displayed on the game screen 60 is a new fan of the player.

### 2-3. Embodiment 2C

In another mode of the present invention, the attributes of spectators who cheer for a player, for example, may be set in advance to control the display so that the attributes of the spectators who cheer for the player are changed when the player succeeds in making a challenging shot or a safe shot. The attributes of spectators indicate the types of spectators or the natures of spectators, for example, the age spectrum or gender distribution of spectators.

### 2-3-1. Functions Implemented in Embodiment 2C

Embodiment 2C describes a case where the display method of each spectator image 82 is varied depending on the attributes of spectators shown in the spectator image 82.

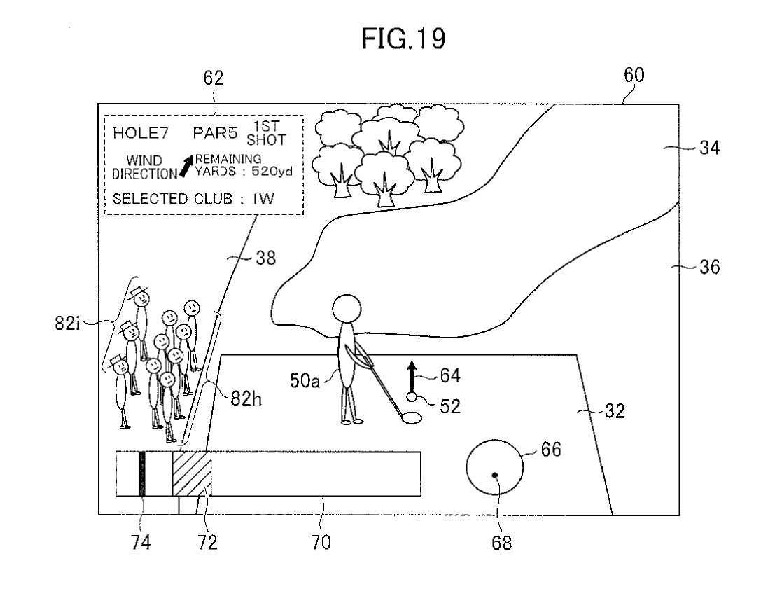

FIG. 19 is a figure illustrating an example of the game screen 60 in Embodiment 2C. Spectator images 82h and 82i are displayed in, for example, the OB zone 38 on the game screen 60. In Embodiment 2C, attributes are set for spectators shown by the spectator images 82h and 82i. For example, a younger age spectrum is set for spectators shown in the spectator image 82h and an older age spectrum is set for spectators shown in the spectator image 82i. When the first player succeeds in making a challenging shot or a safe shot, the attributes of the spectators shown in the spectator images 82 change.

Embodiment 2C describes a case where the game data storing unit 90 stores, for each player, spectator attribute data about the attributes of spectators who have the player as a cheering subject. The spectator attribute data is stored in association with, for example, information that identifies the player.

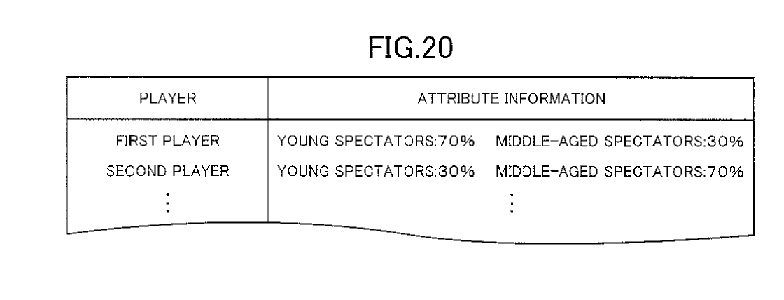

FIG. 20 is a figure illustrating a data storage example of the spectator attribute data. As illustrated in FIG. 20, information that identifies a player is associated with information about the attributes of spectators who cheer for the player. In the data storage example of FIG. 20, for example, the age spectrum of spectators who cheer for the first player is younger than the age spectrum of spectators who cheer for the second player. The attributes of the spectators cheering for the respective players change when the current player succeeds in making a challenging shot or a safe shot.

Embodiment 2C describes a case where the display information includes information about a spectator attribute data changing method. In other words, the display information indicates methods of changing the attributes of spectators that are shown in the spectator images 82 displayed when a player performs a game operation.

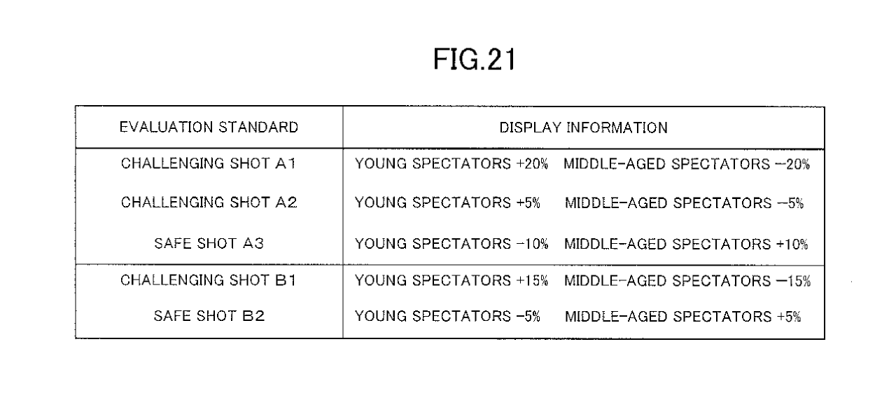

FIG. 21 is a figure illustrating still another data storage example of the display information. The stored display information is, for example, information about a method of changing the attributes of spectators who cheer for a player who has succeeded in making a challenging shot. Specifically, the display information indicates, as a method of changing the attributes of spectators who cheer for the player, a method of changing the age spectrum or the gender distribution. As illustrated in FIG. 21, the age spectrum of spectators who cheer for a player is lowered when the player succeeds in making a challenging shot. When a player succeeds in making a safe shot, on the other hand, the age spectrum of spectators who cheer for the player is raised.

A case is described in which the game operation evaluating unit 102 of Embodiment 2C controls the display of the spectator images 82 by changing the attributes of spectators who have the current player as a cheering subject based on the result of determination of the determining unit 100 and on the display information that is associated with the evaluation standard. In other words, the spectator images 82 are displayed on the game screen 60 based on attributes that are indicated by the changed spectator attribute data.

In the case where the determining unit 100 has determined that the evaluation standard is satisfied, for example, the relevant spectator image 82 is changed so that the age spectrum of the spectators is lowered. In the opposite case, where the determining unit 100 has not determined that the evaluation standard is satisfied, for example, the attributes of the spectators may not be changed.

### 2-3-2. Processing Executed in Embodiment 2C

The same processing as in FIGS. 14 and 15 is executed in Embodiment 2C. However, in S23, the attributes of spectators who cheer for the player who is about to make a shot are identified and, in S24, the spectator image 82 that shows the spectators having the identified attributes is displayed on the game screen 60.

In S35, the spectator attribute data is updated based on methods of changing the attributes of the spectators that are associated with the challenging shot or the safe shot. In S36, the display of the spectator images 82 on the game screen 60 is updated based on the attributes of the spectators that are updated in S35. In the case where the player succeeds in making a challenging shot, for example, the display is controlled so that the age spectrum of the spectators who cheer for the player becomes younger. In the opposite case where the player succeeds in making a safe shot, for example, the display is controlled so that the age spectrum of the spectators who cheer for the player is raised.

According to the game system 1 of Embodiment 2C, when a player makes a challenging shot or a safe shot, the display method of the spectator images 82 can be changed so that the attributes of spectators who cheer for the player are changed based on the result of the challenging shot or the safe shot. The player thus understands that the attributes of the player's fans have really been changed as a result of an evaluation on the specifics of the shot that the player has made, and the fun of the game is accordingly improved.

Embodiments 2A, 2B, and 2C described above may be combined with one another. For instance, when a player succeeds in making a challenging shot, Embodiments 2A and 2C may be combined so that a given number of young spectators are added, or Embodiments 2B and 2C may be combined so that young spectators who have cheered for the other player now cheer for the current player.

### 3. Modification Examples

The present invention is not limited to the embodiments described above, and can be modified suitably without departing from the spirit of the invention.

(1) For example, in the case of executing a game in which the characters 50 operated by players move a moving object (e.g., the ball 52) as in the embodiments, the game operation evaluating unit 102 may give an evaluation that is varied depending on the attributes of the characters 50 operated by the players. The attribute of one character 50 is a parameter unique to the character 50, for example, the personality or ability (e.g., the ability value or skill) of the character 50. Information indicating the attributes of the characters 50 is stored in the game data storing unit 90.

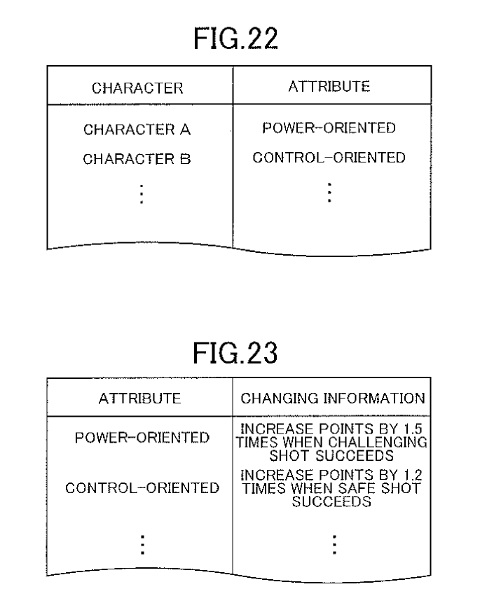

FIG. 22 is a figure illustrating a data storage example of data that indicates character attributes. As illustrated in the example of FIG. 22, for each character 50, information that identifies the character 50 is stored in association with attribute information indicating the attribute of the character 50. Attribute information indicating the attribute of the character 50 that is operated by a player is obtained by referring to the association data of FIG. 22.

Modification Example (1) describes a case where the game operation evaluating unit 102 evaluates a game operation performed by a player based on the result of determination of the determining unit 100 and on the attribute of the character 50 that is operated by the player. For instance, how high or low an evaluation is passed on a game operation performed by a player is changed based on the attribute of a character that is operated by the player. For each character 50, the attribute of the character 50 may be stored in association with, for example, changing information which indicates a method of changing an evaluation on a game operation performed by a player who operates the character 50.

FIG. 23 is a figure illustrating the association between the attribute of one character 50 and a piece of changing information. As illustrated in FIG. 23, the changing information is information defining how an evaluation indicated by the evaluation information is changed depending on the attribute of the character 50 of interest. The changing information defines, for example, how many more points or how many less points are to be given to a player, or a display control method (e.g., the amount of change in the rate of increase of spectators).

The game operation evaluating unit 102 changes an evaluation on a player's game operation based on the changing information that is associated with the attribute of the character 50 operated by the player.

When the attribute of the character 50 operated by a player is a power-oriented type, it is likely that selecting a challenging shot is expected from spectators, and points to be given to the player or display control (e.g., the rate of increase of spectators) in the changing information may therefore be set so that the player is evaluated highly when selecting a challenging shot and succeeding in making the challenging shot.

When the attribute of the character 50 operated by a player is a control-oriented type, on the other hand, it is likely that selecting a safe shot is expected from spectators, and points to be given to the player or display control (e.g., the rate of increase of spectators) in the changing information may therefore be set so that the player is evaluated highly when selecting a safe shot and succeeding in making the safe shot.

According to Modification Example (1), the attribute of the character 50 operated by a player can be reflected in an evaluation of a game operation performed by the player.

Alternatively, in the case where the character 50 operated by a player is of power-oriented type, the character 50 is likely to make a challenging shot successfully, and the changing information may therefore be set so that fewer points are given, or the rate of increase of spectators is low, when a challenging shot succeeds. Similarly, the character 50 who is of control-oriented type is likely to make a safe shot successfully, and the changing information may therefore be set so that fewer points are given, or the rate of increase of spectators is low, when a safe shot succeeds.

(2) To give another example, while the embodiments have described a case where a player who is about to perform a game operation specifies an evaluation standard and the player's game operation is evaluated based on the evaluation standard, an evaluation standard may be selected by an opponent player or by a user who is watching the game. In this case, the player who is about to perform a game operation is evaluated on whether or not the player succeeds in making a shot that satisfies an evaluation standard specified by an opponent player or a user watching the game.

(3) To give still another example, while the embodiments have described a case where a game operation performed by a player is evaluated by giving points or by processing to control the display of the spectator images 82, other methods may be used to reflect the result of a game operation evaluation. Examples of other methods of reflecting an evaluation of a player include displaying a given indicator on the game screen 60 when the deviation amount obtained by the determining unit 100 is within a given range, applying animation processing to the spectator images 82, and changing a parameter that indicates the ability value of the character 50 of the player.

The game data storing unit 90 may also store, for example, information (e.g., a flag) indicating whether or not the result of movement of the ball 52 satisfies an evaluation standard in association with the evaluation standard. The value of this flag changes from “0” to “1” when, for example, a game operation performed by a player results in a successful challenging shot or safe shot. In other words, a change in the value of the flag which is based on the result of determination of the determining unit 100 may be used in an evaluation on a game operation.

In this case, a player aims, for example, to succeed in making every challenging shot or safe shot that is set in the game space 30. In other words, a player aims to perform game operations that satisfy all evaluation standards. This way, a player will play a game so as to complete assignment shots given to the player, instead of simply competing on the basis of a golf score, and the fun of the game is improved.

(4) To give yet still another example, while the description given above deals with a case where a game operation performed by a player is evaluated based on the deviation amount obtained by the determining unit 100, how a game operation is evaluated is not limited thereto. The game system 1 is only required to evaluate a player's game operation by comparing the result of movement of the ball 52 that is caused by the player's game operation against an evaluation standard.

A game operation performed by a player may also be evaluated by, for example, comparing the moving direction or moving speed of the ball 52 that is calculated based on the player's game operation against a moving direction or a moving speed that is indicated by an evaluation standard in the case where the moving direction (e.g., an angle at which the ball shoots out) or moving speed (e.g., the initial speed) of the ball 52 is stored as an evaluation standard.

Another example of information that can be stored as an evaluation standard is information about the point of arrival of the ball 52 from one of the areas 76. In this case, a game operation performed by a player is evaluated by comparing the arrival point of the ball 52 that is calculated based on the player's game operation against a landing point indicated by an evaluation standard.

(5) To give yet another example, while the embodiments have described a case where the evaluation information is stored in association with an evaluation standard, the evaluation information does not always need to be stored. In this case, fixed points may uniformly be given to players who succeed in making a challenging shot or a safe shot.

The embodiments have described a case where the guidance unit 92 presents guidance on evaluation standards, but guidance on evaluation standards does not always need to be presented to players. It is also not always necessary to specify an evaluation standard, although the specification receiving unit 94 receives specification of an evaluation standard in the case described in the embodiments. In this case, the processing of S5 to S7 is not executed and, for example, the result of determination of S3 is stored in the main memory unit 16 or the like to be referred to in S10 and used in determining whether or not the current shot is a challenging shot or a safe shot.

(6) While the description given above deals with a case where a golf game is executed in the game system 1, the game system 1 can execute any sport video game that uses a moving object. Examples of sport video games other than a golf game that can be executed include a gateball game and a billiard game. The game system 1 is only required to compare an evaluation standard of a moving object that is used in those games and the result of movement of the moving object that is caused by a player's game operation.

(7) The embodiments have described a case where one of the game devices 10 included in the game system 1 plays the role of a server. Alternatively, the game system 1 may include a game server. In this case, the game devices 10 operated by the respective players transmit the specifics of operations to the game server. The game server which receives the specifics of operations from the respective game devices 10 operates the same way as in the game devices 10 in the embodiments. In other words, the game server does not include means provided for a player to perform various operations, and has means for obtaining only the result of detection of various operations performed by a player.

The game server updates game situation data based on the specifics of operations collected from the respective game devices 10. The updated game situation data is distributed to the game devices 10. The game devices 10 display a game screen based on the distributed game situation data. In other words, the game server does not include means for displaying a game screen itself, and has means for displaying a game screen on the respective game devices 10 by transmitting the game situation data. The game system 1 may thus be designed so that a game server has overall control of a game executed in the game system 1.

As another alternative to the case described in the embodiments, where one of the game devices 10 plays the role of a game server, the game devices 10 may exchange data indicating the specifics of the player's operation with one another. In this case, the game devices 10 update the game situation data by obtaining the specifics of operations of other players via a network. The game situation data updated in the respective game machines 10 may maintain consistency through periodic exchange with one another.

The game system 1 which includes a plurality of game devices 10 in the embodiments may instead include one game device 10. In this case, the first player and the second player compete with each other by using the operating key unit 20 that is included in the same game device 10.

(8) The number of players may be two or more, for example. Further, instead of a competition between players, which has been described, the opponent may be a computer or the executed game may be a game that is played by one player. In other words, the present invention may be applied to, for example, a case where a player practices playing a golf game by themselves.

1. A game device for executing a sport video game that uses a moving object, comprising:
means for obtaining evaluation standard data, which associates an area in a game space with an evaluation standard for evaluating a result of movement of the moving object from a point inside the area, from means for storing the evaluation standard data;
moving control means for moving the moving object from a moving start point based on a game operation performed by a player;
determining means for determining whether or not a result of movement of the moving object from the moving start point satisfies the evaluation standard that is associated with the area that contains the moving start point; and
game operation evaluating means for evaluating the game operation performed by the player based on a result of the determination of the determining means.

2. The game device according to claim 1,
wherein the evaluation standard indicated by the evaluation standard data indicates a standard for at least one of a moving path, arrival point, moving direction, moving speed, and moving distance of the moving object from the point inside the area, and
wherein the determining means determines whether or not at least one of the moving path, arrival point, moving direction, moving speed, and moving distance of the moving object from the moving start point satisfies the evaluation standard that is associated with the area that contains the moving start point.

3. The game device according to claim 1, further comprising means for obtaining evaluation information about a method of evaluating the game operation performed by the player from means for storing the evaluation information in association with the evaluation standard,
wherein, in a case where the result of the movement of the moving object from the moving start point satisfies the evaluation standard that is associated with the area that contains the moving start point, the game operation evaluating means evaluates the game operation performed by the player based on the evaluation information that is associated with the evaluation standard.

4. The game device according to claim 1, further comprising guidance means for presenting guidance to the player on the evaluation standard that is associated with the area that contains the moving start point,
wherein the determining means determines whether or not the result of the movement of the moving object from the moving start point satisfies the evaluation standard that is presented by the guidance means.

5. The game device according to claim 1, further comprising specification receiving means for receiving specification about the evaluation standard that is associated with the area that contains the moving start point from any one of the player, an opponent of the player, and a user watching the game,
wherein the determining means determines whether or not the result of the movement of the moving object from the moving start point satisfies the specified evaluation standard which is received by the specification receiving means.

6. The game device according to claim 1, further comprising means for obtaining display information about a method of displaying a spectator image, which shows a spectator of the sport, from means for storing the display information in association with the evaluation standard,
wherein the game operation evaluating means comprises means for displaying the spectator image on a game screen, and
wherein the game operation evaluating means evaluates the game operation performed by the player by controlling display of the spectator image based on the result of the determination of the determining means and the display information that is associated with the evaluation standard.

7. The game device according to claim 6,
wherein the spectator image shows one spectator or a plurality of the spectators,
wherein the game device further comprises means for obtaining spectator count data, which is about a count of spectators shown in the spectator image, from means for storing the spectator count data,
wherein the display information comprises information about a method of changing the spectator count data, and
wherein the game operation evaluating means controls the display of the spectator image by changing the count of spectators shown in the spectator image based on the result of the determination of the determining means and the display information that is associated with the evaluation standard.

8. The game device according to claim 6,
wherein how the spectator image is displayed varies depending on who is a cheering subject of the one spectator or the plurality of the spectators,
wherein the game device further comprises means for obtaining cheering subject data, which is about a cheering subject of the one spectator or the plurality of the spectators, from means for storing the cheering subject data,
wherein the display information comprises information about a method of changing the cheering subject data, and
wherein the game operation evaluating means controls the display of the spectator image by changing the cheering subject of the one spectator or the plurality of the spectators based on the result of the determination of the determining means and the display information that is associated with the evaluation standard.

9. The game device according to claim 6,
wherein how the spectator image is displayed varies depending on an attribute of the one spectator or attributes of the plurality of the spectators,
wherein the game device further comprises means for obtaining spectator attribute data, which is about the attribute of the one spectator or the attributes of the plurality of the spectators, the one spectator or the plurality of the spectators having the player as a cheering subject, from means for storing the spectator attribute data,
wherein the display information comprises information about a method of changing the spectator attribute data, and
wherein the game operation evaluating means controls the display of the spectator image by changing the attribute of the one spectator or the attributes of the plurality of the spectators, the one spectator or the plurality of the spectators having the player as a cheering subject, based on the result of the determination of the determining means and the display information that is associated with the evaluation standard.

10. The game device according to claim 1,
wherein the moving object is moved in the game by a character which is operated by the player,
wherein the game device further comprises means for obtaining information that indicates an attribute of the character operated by the player, from means for storing the information, and
wherein the game operation evaluating means evaluates the game operation performed by the player based on the result of the determination of the determining means and the information that indicates the attribute of the character operated by the player.

11. A method of controlling a game device for executing a sport video game that uses a moving object, the method comprising:
a step of obtaining evaluation standard data, which associates an area in a game space with an evaluation standard for evaluating a result of movement of the moving object from a point inside the area, from means for storing the evaluation standard data;
a moving control step of moving the moving object from a moving start point based on a game operation performed by a player;
a determining step of determining whether or not a result of movement of the moving object from the moving start point satisfies the evaluation standard that is associated with the area that contains the moving start point; and
a game operation evaluating step of evaluating the game operation performed by the player based on a result of the determination of the determining step.

12. A game system for executing a sport video game that uses a moving object, comprising:
means for obtaining evaluation standard data, which associates an area in a game space with an evaluation standard for evaluating a result of movement of the moving object from a point inside the area, from means for storing the evaluation standard data;
game operation detecting means for detecting a game operation performed by a player;
moving control means for moving the moving object from a moving start point based on a result of detection by the game operation detecting means;
determining means for determining whether or not a result of movement of the moving object from the moving start point satisfies the evaluation standard that is associated with the area that contains the moving start point; and
game operation evaluating means for evaluating the game operation performed by the player based on a result of the determination of the determining means.

13. A non-transitory computer-readable information storage medium having recorded thereon a program for causing a computer to function as a game device for executing a sport video game that uses a moving object, the game device comprising:
means for obtaining evaluation standard data, which associates an area in a game space with an evaluation standard for evaluating a result of movement of the moving object from a point inside the area, from means for storing the evaluation standard data;
moving control means for moving the moving object from a moving start point based on a game operation performed by a player;
determining means for determining whether or not a result of movement of the moving object from the moving start point satisfies the evaluation standard that is associated with the area that contains the moving start point; and
game operation evaluating means for evaluating the game operation performed by the player based on a result of the determination of the determining means.

14. (canceled)
